(19) United States
(12) Patent Application Publication
(10) Pub. No.: US 2026/0296035 A1
(43) Pub. Date: Oct. 1, 2026

(54) LIQUID ACCOMMODATION BODY AND METHOD OF POURING LIQUID INTO LIQUID ACCOMMODATION BODY

(71) Applicant: SEIKO EPSON CORPORATION, Tokyo (JP)

(72) Inventors: Koji KUDO, Shiojiri-shi (JP); Yoshihiro KOIZUMI, Shiojiri-shi (JP)

(73) Assignee: SEIKO EPSON CORPORATION, Tokyo (JP)

(21) Appl. No.: 19/577,503

(22) Filed: Mar. 25, 2026

(30) Foreign Application Priority Data
Mar. 26, 2025 (JP) 2025-051228

(51) Int. Cl. B41J 2/175; B41J 2/19

(52) U.S. Cl. CPC B41J 2/17506; B41J 2/17513; B41J 2/17523; B41J 2/17596; B41J 2/19; B41J 2002/17516

(57) ABSTRACT

A liquid accommodation body includes an accommodation bag that accommodates liquid and a supply portion that is attached to the accommodation bag. The supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag. The liquid pouring port is a region covered by an end portion of the accommodation bag and is provided upstream of the valve structure in the liquid supply flow path.

The present application is based on, and claims priority from JP Application Serial Number 2025-051228, filed March 26, 2025, the disclosure of which is hereby incorporated by reference herein in its entirety.

### BACKGROUND

### 1. Technical Field

The present disclosure relates to a liquid accommodation body and a method of pouring liquid into a liquid accommodation body.

### 2. Related Art

For example, a liquid accommodation body for supply of liquid to a liquid discharging apparatus is disclosed as in JP-A-2019-198990. In the case of such a liquid accommodation body, a liquid pouring port is formed by cutting off at least a portion of an end portion of an accommodation bag that accommodates the liquid. After the liquid is poured into the accommodation bag through the liquid pouring port formed in such a manner, the accommodation bag is welded so that the liquid pouring port is sealed.

However, in the case of such a liquid accommodation body, the capacity of the accommodation bag is reduced when at least a portion of the end portion of the accommodation bag is cut off and then the accommodation bag is welded so that the liquid pouring port is sealed. As a result, the amount of liquid that can be accommodated in the liquid accommodation body is reduced each time liquid is poured. Therefore, it is desired to improve convenience regarding the pouring of liquid into the liquid accommodation body.

### SUMMARY

According to an aspect of the present disclosure, there is provided a liquid accommodation body including an accommodation bag that accommodates liquid and a supply portion that is attached to the accommodation bag, in which the supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag and the liquid pouring port is a region covered by an end portion of the accommodation bag and is provided upstream of the valve structure in the liquid supply flow path.

According to another aspect of the present disclosure, there is provided a method of pouring liquid into a liquid accommodation body that includes an accommodation bag accommodating liquid and a supply portion attached to the accommodation bag and in which the supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag and the liquid pouring port is a region covered by an end portion of the accommodation bag and is provided upstream of the valve structure in the liquid supply flow path, the method including pouring the liquid into the accommodation bag through the liquid pouring port in a state where the liquid pouring port is open and sealing the liquid pouring port after the liquid is poured into the accommodation bag through the liquid pouring port.

### BRIEF DESCRIPTION OF THE DRAWINGS

FIG. 1 is a schematic view showing a liquid discharging apparatus according to a first embodiment.

FIG. 2 is a perspective view showing a liquid accommodation body of the first embodiment.

FIG. 3 is a perspective view showing a supply portion of the first embodiment and the second embodiment.

FIG. 4 is a schematic cross-sectional view showing a first pouring portion and a second pouring portion of the first embodiment and the second embodiment.

FIG. 5 is a perspective view showing the supply portion of the first embodiment and the second embodiment.

FIG. 6 is a perspective view showing a supply portion of a third embodiment.

### DESCRIPTION OF EMBODIMENTS

### First Embodiment

Hereinafter, an embodiment of a liquid accommodation body and a method of pouring liquid into a liquid accommodation body will be described with reference to the drawings. In the following description, a direction in which the liquid accommodation body is inserted into and removed from a mounting portion of a liquid discharging apparatus will be referred to as an X-axis. An axis intersecting the X-axis will be referred to as a Y-axis. An axis intersecting the X-axis and the Y-axis will be referred to as a Z-axis. One direction along the X-axis will be referred to as a mounting direction X1, and the other direction along the X-axis will be referred to as a separation direction X2. One direction along the Y-axis will be referred to as a first width direction Y1, and the other direction along the Y-axis will be referred to as a second width direction Y2. One direction along the Z-axis will be referred to as a first thickness direction Z1, and the other direction along the Z-axis will be referred to as a second thickness direction Z2. The mounting direction X1 is an example of a first direction. The first thickness direction Z1 is an example of a second direction. The first width direction Y1 is an example of a third direction.

### Configuration of Liquid Discharging Apparatus 10

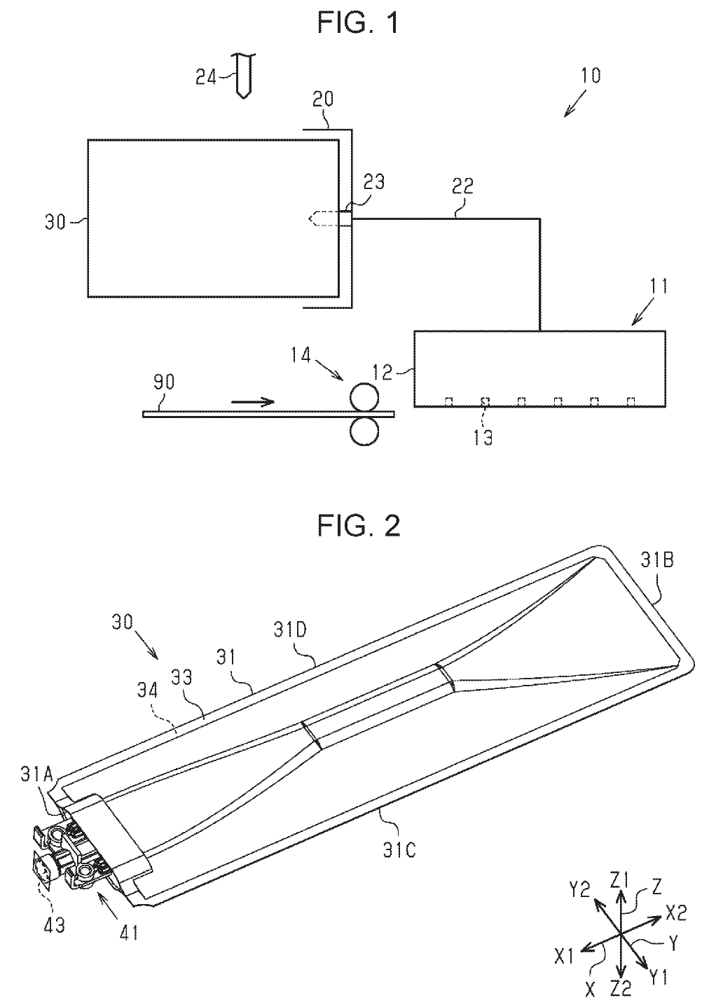

As shown in FIG. 1, a liquid discharging apparatus 10 is configured to perform printing by discharging liquid onto a medium 90. The liquid discharging apparatus 10 may be an ink jet printer that performs printing by discharging ink, which is an example of the liquid, onto the medium 90. The medium 90 may be, for example, paper, cloth, vinyl, a plastic component, a metal component, or the like.

The liquid discharging apparatus 10 includes a liquid discharger 11. The liquid discharger 11 is configured to discharge liquid to the medium 90. The liquid discharger 11 includes a liquid discharging head 12. The liquid discharging head 12 discharges liquid to the medium 90. The liquid discharging head 12 is configured to discharge liquid accommodated in a liquid accommodation body 30 which will be described later.

The liquid discharging head 12 includes a plurality of nozzles 13. The liquid discharging head 12 performs printing by discharging liquid to the medium 90 from the plurality of nozzles 13. The liquid discharging head 12 may be a serial type liquid discharging head or a line type liquid discharging head. In the case of a serial type liquid discharging head, the liquid discharging head 12 performs printing by discharging liquid to the medium 90 while moving. In the case of a line type liquid discharging head, the liquid discharging head 12 is provided to be long in a width direction of the medium 90, and the liquid discharging head 12 performs printing by discharging liquid to the medium 90.

The liquid discharging apparatus 10 may include a transporter 14. The transporter 14 is configured to transport the medium 90. The transporter 14 transports the medium 90 from a medium accommodation section (not shown) to the liquid discharging head 12. The transporter 14 transports, to the outside of the liquid discharging apparatus 10, the medium 90 subjected to printing performed by the liquid discharging head 12. The transporter 14 may include a roller.

The liquid discharging apparatus 10 may include a mounting portion 20. The liquid accommodation body 30 can be attached to and detached from the mounting portion 20. The mounting portion 20 may be configured such that a plurality of the liquid accommodation bodies 30 corresponding to liquid colors can be mounted to the mounting portion 20. The liquid accommodation body 30 accommodates the liquid to be supplied to the liquid discharging head 12. The liquid accommodation body 30 may be an ink cartridge.

The liquid discharging apparatus 10 may include a supply flow path 22. The liquid discharging apparatus 10 may include a plurality of the supply flow paths 22 corresponding to liquid colors. The supply flow path 22 is a flow path through which liquid from the liquid accommodation body 30 mounted to the mounting portion 20 is supplied to the liquid discharging head 12. An upstream end of the supply flow path 22 is coupled to the liquid accommodation body 30 when the liquid accommodation body 30 is mounted to the mounting portion 20. A downstream end of the supply flow path 22 is coupled to the liquid discharging head 12.

The liquid discharging apparatus 10 includes a supply pipe 23. The supply pipe 23 is provided at the upstream end of the supply flow path 22. The supply pipe 23 can be inserted into the liquid accommodation body 30 mounted to the mounting portion 20. The supply pipe 23 may be a supply needle. The liquid discharging apparatus 10 may include a pump (not shown) for supply of liquid from the liquid accommodation body 30 to the liquid discharging head 12. Through the supply flow path 22, liquid may be supplied by means of the hydraulic head.

A pouring pipe 24 can be inserted into the liquid accommodation body 30 removed from the mounting portion 20. The pouring pipe 24 is different from the supply pipe 23. The pouring pipe 24 is a member used to pour liquid into the liquid accommodation body 30. When the pouring pipe 24 is inserted into the liquid accommodation body 30, liquid from a liquid pouring container (not shown) can be poured into the liquid accommodation body 30. The pouring pipe 24 may have the same shape as that of the supply pipe 23.

### Configuration of Liquid Accommodation Body 30

As shown in FIG. 2, the liquid accommodation body 30 includes an accommodation bag 31 and a supply portion 41. The accommodation bag 31 accommodates liquid to be discharged to the medium 90. The accommodation bag 31 has a bag-like shape. The accommodation bag 31 is made of a flexible material.

The accommodation bag 31 may be, for example, rectangular. The accommodation bag 31 includes a first end portion 31A, a second end portion 31B, a third end portion 31C, and a fourth end portion 31D. The first end portion 31A is an end portion of the accommodation bag 31 on the mounting direction X1 side. The second end portion 31B is an end portion of the accommodation bag 31 on the separation direction X2 side. The third end portion 31C is an end portion of the accommodation bag 31 on the first width direction Y1 side. The fourth end portion 31D is an end portion of the accommodation bag 31 on the second width direction Y2 side.

The accommodation bag 31 may include a first sheet member 33 and a second sheet member 34. The first sheet member 33 is a member of the accommodation bag 31 on the first thickness direction Z1 side. The second sheet member 34 is a member of the accommodation bag 31 on the second thickness direction Z2 side.

The accommodation bag 31 may be configured by welding the first sheet member 33 and the second sheet member 34 at the first end portion 31A, the second end portion 31B, the third end portion 31C, and the fourth end portion 31D.

At the first end portion 31A, the first sheet member 33 and the second sheet member 34 are welded with the supply portion 41 interposed therebetween. At the second end portion 31B, the third end portion 31C, and the fourth end portion 31D, the first sheet member 33 and the second sheet member 34 may be welded with no other member interposed therebetween. Accordingly, a space is formed between the first sheet member 33 and the second sheet member 34 in the accommodation bag 31. That is, the accommodation bag 31 can accommodate liquid.

The supply portion 41 is a member for supply of liquid accommodated in the accommodation bag 31 to the liquid discharging apparatus 10. The supply portion 41 is attached to the accommodation bag 31. The supply portion 41 is attached to the accommodation bag 31 through, for example, heat welding. Particularly, the supply portion 41 is attached to the first end portion 31A.

### Configuration of Supply Portion 41

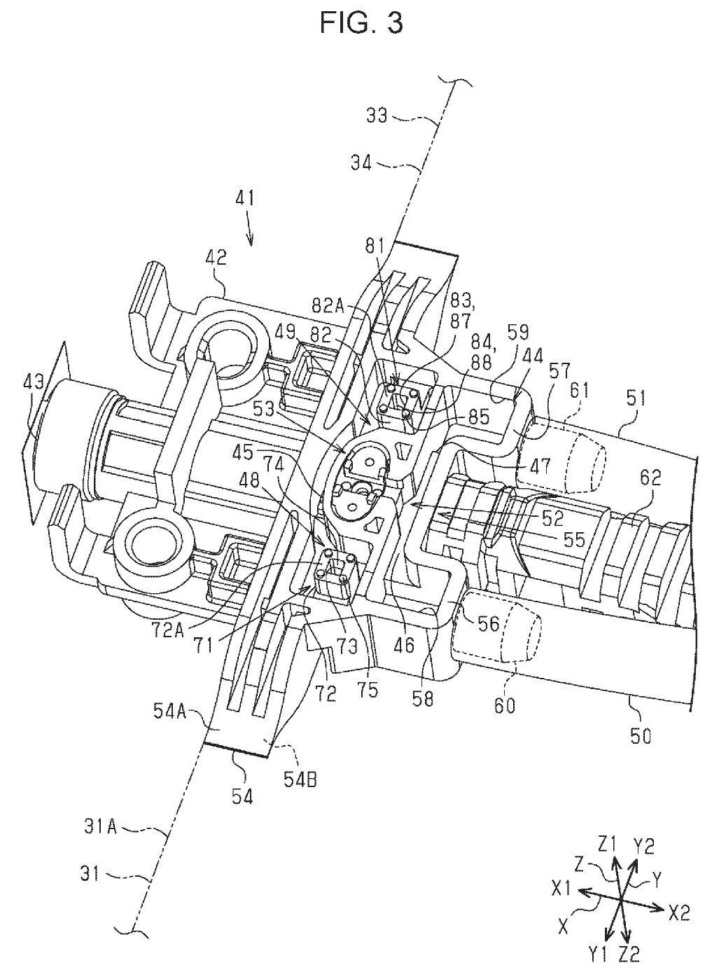

As shown in FIG. 3, the supply portion 41 includes a supply member 42. Although the supply member 42 is made of a resin, the supply member 42 may be made of a material other than the resin. The supply member 42 includes a liquid supply port 43 and a liquid supply flow path 44. That is, the supply portion 41 includes the liquid supply port 43 and the liquid supply flow path 44.

The liquid supply port 43 is provided at the supply member 42 on the mounting direction X1 side. The liquid supply port 43 is provided to be exposed outside the accommodation bag 31 in the mounting direction X1. The liquid supply port 43 can be coupled to the supply pipe 23 of the liquid discharging apparatus 10. Particularly, when the liquid accommodation body 30 is mounted to the mounting portion 20, the supply pipe 23 is inserted into the liquid supply port 43. The liquid supply port 43 may be blocked by a film in a state before the liquid accommodation body 30 is mounted to the mounting portion 20. The liquid supply port 43 communicates with the inside of the accommodation bag 31 via the liquid supply flow path 44.

The liquid supply flow path 44 couples the inside of the accommodation bag 31 and the liquid supply port 43. The liquid supply flow path 44 is a flow path through which liquid accommodated in the accommodation bag 31 is supplied to the liquid discharging apparatus 10 via the liquid supply port 43. The liquid supply flow path 44 may be a flow path formed by a groove formed at the supply member 42.

The liquid supply flow path 44 includes a confluence flow path 45, a first branch flow path 46, and a second branch flow path 47. The confluence flow path 45 extends in the mounting direction X1. The confluence flow path 45 is a flow path that couples the first branch flow path 46 and the second branch flow path 47 to the liquid supply port 43. The liquid supply port 43 is provided at a downstream end of the confluence flow path 45. An upstream end of the confluence flow path 45 is coupled to both a downstream end of the first branch flow path 46 and a downstream end of the second branch flow path 47 at a confluence position 52.

The first branch flow path 46 is a flow path for the coupling of the inside of the accommodation bag 31 and the confluence flow path 45. The first branch flow path 46 may be a flow path that extends in the first width direction Y1 from the confluence position 52 as seen in the first thickness direction Z1 and that is bent toward the separation direction X2 at a position to which the first branch flow path 46 extends in the first width direction Y1.

The second branch flow path 47 is a flow path for the coupling of the inside of the accommodation bag 31 and the confluence flow path 45. The second branch flow path 47 may be a flow path that extends in the second width direction Y2 from the confluence position 52 as seen in the first thickness direction Z1 and that is bent toward the separation direction X2 at a position to which the second branch flow path 47 extends in the second width direction Y2.

The supply portion 41 includes a valve structure 53. The valve structure 53 is provided at the liquid supply flow path 44. Specifically, the valve structure 53 is provided at the confluence flow path 45. The valve structure 53 is provided downstream of the confluence position 52 in the liquid supply flow path 44.

The valve structure 53 is opened when the supply pipe 23 is inserted through the liquid supply port 43. The valve structure 53 is closed when there is no supply pipe 23 inserted through the liquid supply port 43. The valve structure 53 may be composed of, for example, a spring valve. When the valve structure 53 is closed, the valve structure 53 blocks the confluence flow path 45. Accordingly, the valve structure 53 suppresses intrusion of air bubbles in the liquid supply flow path 44.

The supply member 42 includes a welding end portion 54. The welding end portion 54 is provided closer to the separation direction X2 side than the liquid supply port 43 is. The welding end portion 54 is provided closer to the mounting direction X1 side than the valve structure 53 is. The welding end portion 54 may be configured to extend along the Y-axis. The first end portion 31A of the accommodation bag 31 is welded to the welding end portion 54.

The welding end portion 54 includes a first welding surface 54A and a second welding surface 54B. The first welding surface 54A is a surface of the welding end portion 54 on the first thickness direction Z1 side. The second welding surface 54B is a surface of the welding end portion 54 on the second thickness direction Z2 side.

The first sheet member 33 is welded to the first welding surface 54A. The second sheet member 34 is welded to the second welding surface 54B. In this manner, the first sheet member 33 and the second sheet member 34 are welded to the welding end portion 54.

The supply member 42 includes a confluence portion 55. The confluence portion 55 is provided closer to the separation direction X2 side than the welding end portion 54 of the supply member 42 is. The confluence portion 55 constitutes a portion of the first branch flow path 46 and a portion of the second branch flow path 47.

The confluence portion 55 includes a first upper surface 56, a second upper surface 57, a first opening 58, and a second opening 59. The first upper surface 56 is a wall surface on the first thickness direction Z1 side that constitutes a portion of the first branch flow path 46. The second upper surface 57 is a wall surface on the first thickness direction Z1 side that constitutes a portion of the second branch flow path 47. When the accommodation bag 31 is welded to the supply portion 41, an inner surface of the first sheet member 33 is welded to the first upper surface 56 and the second upper surface 57.

The first opening 58 is open on the first thickness direction Z1 side with respect to the first branch flow path 46 at the first upper surface 56. The second opening 59 is open on the first thickness direction Z1 side with respect to the second branch flow path 47 at the second upper surface 57. When the accommodation bag 31 is welded to the supply portion 41 with the inner surface of the first sheet member 33 welded to the first upper surface 56 and the second upper surface 57, the first opening 58 and the second opening 59 are sealed.

The supply member 42 includes a first coupling portion 60. The first coupling portion 60 is provided closer to the separation direction X2 side than the confluence portion 55 is. The first coupling portion 60 protrudes in the separation direction X2 from the confluence portion 55. The first coupling portion 60 constitutes a portion of the first branch flow path 46. The first coupling portion 60 is provided at an upstream end of the first branch flow path 46. The first coupling portion 60 may be tubular. A downstream end of a first tube 50, which will be described later, is coupled to the first coupling portion 60.

The supply member 42 includes a second coupling portion 61. The second coupling portion 61 is provided closer to the separation direction X2 side than the confluence portion 55 is. The second coupling portion 61 protrudes in the separation direction X2 from the confluence portion 55. The second coupling portion 61 constitutes a portion of the second branch flow path 47. The second coupling portion 61 is provided at an upstream end of the second branch flow path 47. The second coupling portion 61 may be tubular. A downstream end of a second tube 51, which will be described later, is coupled to the second coupling portion 61.

The supply portion 41 may include a supporting portion 62. The supporting portion 62 is provided closer to the separation direction X2 side than the confluence portion 55 is. The supporting portion 62 protrudes in the separation direction X2 from the confluence portion 55. The supporting portion 62 is provided at a position at which the supporting portion 62 is interposed between the first coupling portion 60 and the second coupling portion 61 on the Y-axis.

The supporting portion 62 is accommodated in the accommodation bag 31. The supporting portion 62 supports the first tube 50 and the second tube 51 in the accommodation bag 31. The supporting portion 62 may be integrated with the supply member 42, or may be separately provided from the supply member 42 and attachable to and detachable from the supply member 42.

The liquid accommodation body 30 may include the first tube 50. The first tube 50 is a member for supply of liquid. The first tube 50 is accommodated in the accommodation bag 31. An upstream end of the first tube 50 is coupled to the inside of the accommodation bag 31. The first tube 50 is included in the liquid supply flow path 44.

The liquid accommodation body 30 may include the second tube 51. The second tube 51 is a member for supply of liquid. The second tube 51 is accommodated in the accommodation bag 31. An upstream end of the second tube 51 is coupled to the inside of the accommodation bag 31. The second tube 51 is included in the liquid supply flow path 44.

The supply member 42 includes a first pouring portion 71. The first pouring portion 71 is provided closer to the first width direction Y1 side than the confluence flow path 45 is. The first pouring portion 71 is provided closer to the first width direction Y1 side than the valve structure 53 is. The first pouring portion 71 is provided between the welding end portion 54 and the confluence portion 55 on the X-axis. The first pouring portion 71 is a portion used to pour liquid into the accommodation bag 31.

The first pouring portion 71 may include a first bypass region 48. The first bypass region 48 is provided closer to the first width direction Y1 side than the confluence flow path 45 is. The first bypass region 48 is provided between the welding end portion 54 and the confluence portion 55 on the X-axis.

The first bypass region 48 is surrounded by an inner wall. The first bypass region 48 communicates with the confluence flow path 45 at a position downstream of the valve structure 53. The first bypass region 48 is provided to be open in the first thickness direction Z1. When the accommodation bag 31 is welded to the supply portion 41, the first bypass region 48 is sealed by the first sheet member 33.

The first pouring portion 71 includes a first protruding portion 72. That is, the supply portion 41 includes the first protruding portion 72. The first protruding portion 72 is an example of a protruding portion. The first protruding portion 72 is made of a resin. The first protruding portion 72 is configured to protrude in the first thickness direction Z1 at the first bypass region 48. The first protruding portion 72 includes a first protrusion surface 72A. The first protrusion surface 72A is an upper surface of the first protruding portion 72.

The first protruding portion 72 includes a first liquid pouring port 73 and a first pouring flow path 74. That is, the supply portion 41 includes the first liquid pouring port 73 and the first pouring flow path 74. The first liquid pouring port 73 is provided at the first pouring portion 71. Specifically, the first liquid pouring port 73 is provided at the first protrusion surface 72A. The first liquid pouring port 73 is an example of a liquid pouring port. The first liquid pouring port 73 is provided on the first width direction Y1 side with respect to the valve structure 53. The first liquid pouring port 73 is open in the first thickness direction Z1.

The first pouring flow path 74 is a flow path extending in the second thickness direction Z2 from the first liquid pouring port 73. The first pouring flow path 74 is a flow path that is coupled to the inside of the accommodation bag 31 from the first liquid pouring port 73 via a first communication flow path (not shown). The first communication flow path may be provided on the second thickness direction Z2 side with respect to the confluence portion 55.

As described above, the first liquid pouring port 73 is coupled to the inside of the accommodation bag 31 via the first pouring flow path 74 and the first communication flow path. Accordingly, liquid can be poured into the accommodation bag 31 through the first liquid pouring port 73, via the first pouring flow path 74 and the first communication flow path. That is, through the first liquid pouring port 73, liquid can be poured into the accommodation bag 31.

The first pouring flow path 74 and the first communication flow path are included in the liquid supply flow path 44. That is, it can be said that the first liquid pouring port 73 is provided at an upstream end of the liquid supply flow path 44. The first liquid pouring port 73 is provided upstream of the valve structure 53 in the liquid supply flow path 44.

When the accommodation bag 31 is welded to the supply portion 41, the first liquid pouring port 73 is covered by the accommodation bag 31. In this manner, the first liquid pouring port 73 is sealed in a state of being covered by the accommodation bag 31. Specifically, the first liquid pouring port 73 is a region covered by the first end portion 31A.

The supply member 42 includes a second pouring portion 81. The second pouring portion 81 is provided closer to the second width direction Y2 side than the confluence flow path 45 is. The second pouring portion 81 is provided closer to the second width direction Y2 side than the valve structure 53 is. The second pouring portion 81 is provided between the welding end portion 54 and the confluence portion 55 on the X-axis. The second pouring portion 81 is a portion used to pour liquid into the accommodation bag 31.

The second pouring portion 81 may include a second bypass region 49. The second bypass region 49 is provided closer to the second width direction Y2 side than the confluence flow path 45 is. The second bypass region 49 is provided between the welding end portion 54 and the confluence portion 55 on the X-axis.

The second bypass region 49 is surrounded by an inner wall. The second bypass region 49 communicates with the confluence flow path 45 at a position downstream of the valve structure 53. The second bypass region 49 is provided to be open in the first thickness direction Z1. When the accommodation bag 31 is welded to the supply portion 41, the second bypass region 49 is sealed by the first sheet member 33.

The second pouring portion 81 includes a second protruding portion 82. That is, the supply portion 41 includes the second protruding portion 82. The second protruding portion 82 is an example of a protruding portion. The second protruding portion 82 is made of a resin. The second protruding portion 82 is configured to protrude in the first thickness direction Z1 at the second bypass region 49. The second protruding portion 82 includes a second protrusion surface 82A. The second protrusion surface 82A is an upper surface of the second protruding portion 82.

The second protruding portion 82 includes a second liquid pouring port 83 and a second pouring flow path 84. That is, the supply portion 41 includes the second liquid pouring port 83 and the second pouring flow path 84. The second liquid pouring port 83 is provided at the second pouring portion 81. Specifically, the second liquid pouring port 83 is provided at the second protrusion surface 82A. The second liquid pouring port 83 is an example of a liquid pouring port. The second liquid pouring port 83 is provided on the second width direction Y2 side with respect to the valve structure 53. The first liquid pouring port 73 and the second liquid pouring port 83 are provided at such positions that the liquid supply flow path 44 is interposed therebetween on the Y-axis. The second liquid pouring port 83 is open in the first thickness direction Z1.

The second pouring flow path 84 is a flow path extending in the second thickness direction Z2 from the second liquid pouring port 83. The second pouring flow path 84 is a flow path that is coupled to the inside of the accommodation bag 31 from the second liquid pouring port 83 via a second communication flow path (not shown). The second communication flow path may be provided on the second thickness direction Z2 side with respect to the confluence portion 55.

As described above, the second liquid pouring port 83 is coupled to the inside of the accommodation bag 31 via the second pouring flow path 84 and the second communication flow path. Accordingly, liquid can be poured into the accommodation bag 31 through the second liquid pouring port 83, via the second pouring flow path 84 and the second communication flow path. That is, through the second liquid pouring port 83, liquid can be poured into the accommodation bag 31.

The second pouring flow path 84 and the second communication flow path are included in the liquid supply flow path 44. That is, it can be said that the second liquid pouring port 83 is provided at the upstream end of the liquid supply flow path 44. The second liquid pouring port 83 is provided upstream of the valve structure 53 in the liquid supply flow path 44.

When the accommodation bag 31 is welded to the supply portion 41, the second liquid pouring port 83 is covered by the accommodation bag 31. In this manner, the second liquid pouring port 83 is sealed in a state of being covered by the accommodation bag 31. Specifically, the second liquid pouring port 83 is a region covered by the first end portion 31A.

### Configuration of First Pouring Portion 71 and Second Pouring Portion 81

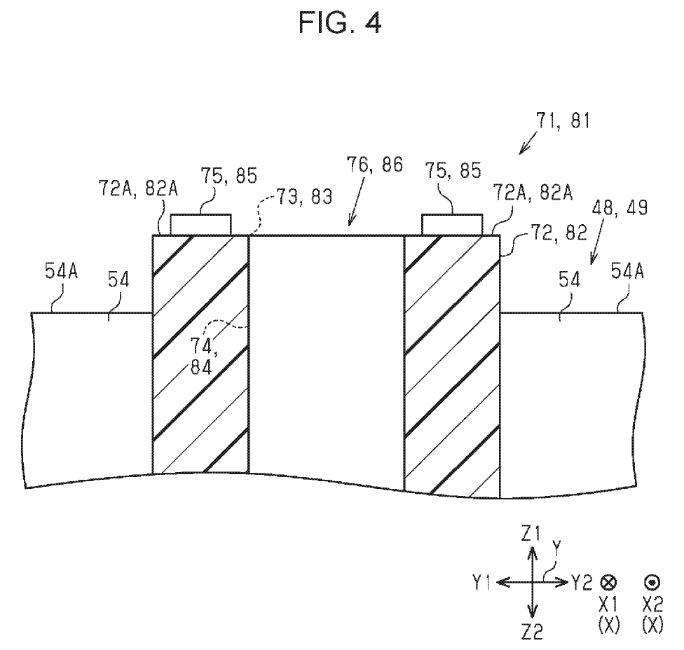

As shown in FIG. 4, the first protruding portion 72 of the first pouring portion 71 is higher than the welding end portion 54 in the first thickness direction Z1. Specifically, the first protrusion surface 72A is provided at a position higher than the first welding surface 54A in the first thickness direction Z1.

The first protruding portion 72 is higher than the confluence portion 55 shown in FIG. 3 in the first thickness direction Z1. Specifically, the first protrusion surface 72A is higher than the first upper surface 56 shown in FIG. 3 in the first thickness direction Z1. The first protruding portion 72 is higher than the inner wall constituting the first bypass region 48. The first protruding portion 72 may protrude highest in the first thickness direction Z1 at the supply member 42.

The first pouring portion 71 includes first projecting portions 75. The first projecting portions 75 are provided at the first protrusion surface 72A. The first projecting portions 75 are provided to protrude in the first thickness direction Z1 from the first protrusion surface 72A in the vicinity of the first liquid pouring port 73. In the present embodiment, the first projecting portions 75 may be respectively provided at four corners of the first protrusion surface 72A. Gaps 76 are provided between the first projecting portions 75, the gaps 76 being provided closer to the first thickness direction Z1 side than the first protruding portion 72 is. The first projecting portions 75 correspond to examples of a first gap forming member for provision of the gaps 76.

Similarly, the second protruding portion 82 of the second pouring portion 81 is higher than the welding end portion 54 in the first thickness direction Z1. Specifically, the second protrusion surface 82A is provided at a position higher than the first welding surface 54A in the first thickness direction Z1.

In the first thickness direction Z1, the second protruding portion 82 is higher than the confluence portion 55 shown in FIG. 3. Specifically, the second protrusion surface 82A is higher than the second upper surface 57 shown in FIG. 3 in the first thickness direction Z1. The second protruding portion 82 is higher than the inner wall constituting the second bypass region 49. The second protruding portion 82 may protrude highest in the first thickness direction Z1 at the supply member 42.

The second pouring portion 81 includes second projecting portions 85. The second projecting portions 85 are provided at the second protrusion surface 82A. The second projecting portions 85 are provided to protrude in the first thickness direction Z1 from the second protrusion surface 82A in the vicinity of the second liquid pouring port 83. In the present embodiment, the second projecting portions 85 may be respectively provided at four corners of the second protrusion surface 82A. Gaps 86 are provided between the second projecting portions 85, the gaps 86 being provided closer to the first thickness direction Z1 side than the second protruding portion 82 is. The second projecting portions 85 correspond to examples of a second gap forming member for provision of the gaps 86.

### Method of Pouring Liquid into Liquid Accommodation Body 30

Here, a method of pouring liquid into the liquid accommodation body 30 will be described in detail.

As shown in FIG. 3, when liquid is to be poured into the liquid accommodation body 30 for the first time, the accommodation bag 31 is welded to the supply portion 41 in a state where the supply portion 41 is attached to the first end portion 31A of the accommodation bag 31. In this case, the first sheet member 33 and the second sheet member 34 are respectively welded to the first welding surface 54A and the second welding surface 54B, so that the accommodation bag 31 is sealed.

When the accommodation bag 31 is welded to the supply portion 41 in this manner, the valve structure 53, the welding end portion 54, the confluence portion 55, the first bypass region 48, and the second bypass region 49 are covered by the first sheet member 33 from the first thickness direction Z1 side. In this manner, the first bypass region 48, the second bypass region 49, the first opening 58, and the second opening 59 are sealed when the accommodation bag 31 is welded to the supply portion 41.

Meanwhile, in the first bypass region 48, the first sheet member 33 is temporarily welded to the first protruding portion 72. In this case, the first sheet member 33 is welded to upper surfaces of the first projecting portions 75 in a state where the gaps 76 are provided between the first sheet member 33 and the first protrusion surface 72A. Therefore, in the first bypass region 48, the first liquid pouring port 73 communicates with the confluence flow path 45 without being sealed in the accommodation bag 31.

As with the first pouring portion 71, in the second bypass region 49, the first sheet member 33 is also temporarily welded to the second pouring portion 81. In this case, the first sheet member 33 is welded to upper surfaces of the second projecting portions 85 in a state where the gaps 86 are provided between the first sheet member 33 and the second protrusion surface 82A. Therefore, in the second bypass region 49, the second liquid pouring port 83 communicates with the confluence flow path 45 without being sealed in the accommodation bag 31.

When the pouring pipe 24 is inserted into the liquid supply port 43 in such a case, liquid is poured through the liquid supply port 43 and the confluence flow path 45 in a state where the valve structure 53 is closed. The liquid poured through the liquid supply port 43 and the confluence flow path 45 flows into the first bypass region 48 and the second bypass region 49.

The liquid flowing into the first bypass region 48 is poured into the first liquid pouring port 73 via the gaps 76. The liquid poured into the first liquid pouring port 73 is supplied to the inside of the accommodation bag 31 via the first pouring flow path 74 and the first communication flow path.

The liquid flowing into the second bypass region 49 is poured into the second liquid pouring port 83 via the gaps 86. The liquid poured into the second liquid pouring port 83 is supplied to the inside of the accommodation bag 31 via the second pouring flow path 84 and the second communication flow path.

Thereafter, the first sheet member 33 is finally welded to the first protruding portion 72. Accordingly, the first projecting portions 75 are melted due to welding heat, so that the first sheet member 33 is welded to the first protrusion surface 72A without the gaps 76. In this manner, the first liquid pouring port 73 is sealed by the first sheet member 33.

Similarly, the first sheet member 33 is finally welded to the second protruding portion 82. Accordingly, the second projecting portions 85 are melted due to welding heat, so that the first sheet member 33 is welded to the second protrusion surface 82A without the gaps 86. In this manner, the second liquid pouring port 83 is sealed by the first sheet member 33.

Accordingly, the first opening 58, the second opening 59, the first liquid pouring port 73, and the second liquid pouring port 83 are sealed by the first sheet member 33. Therefore, it is possible to lower a probability that liquid accommodated in the accommodation bag 31 leaks through the first opening 58, the second opening 59, the first liquid pouring port 73, and the second liquid pouring port 83.

When the valve structure 53 is open, the liquid accommodated in the accommodation bag 31 is supplied to the liquid discharging apparatus 10 via the first tube 50, the first branch flow path 46, the second tube 51, the second branch flow path 47, the confluence flow path 45, and the liquid supply port 43. When the valve structure 53 is closed, the liquid accommodated in the accommodation bag 31 is not supplied to the outside of the liquid accommodation body 30.

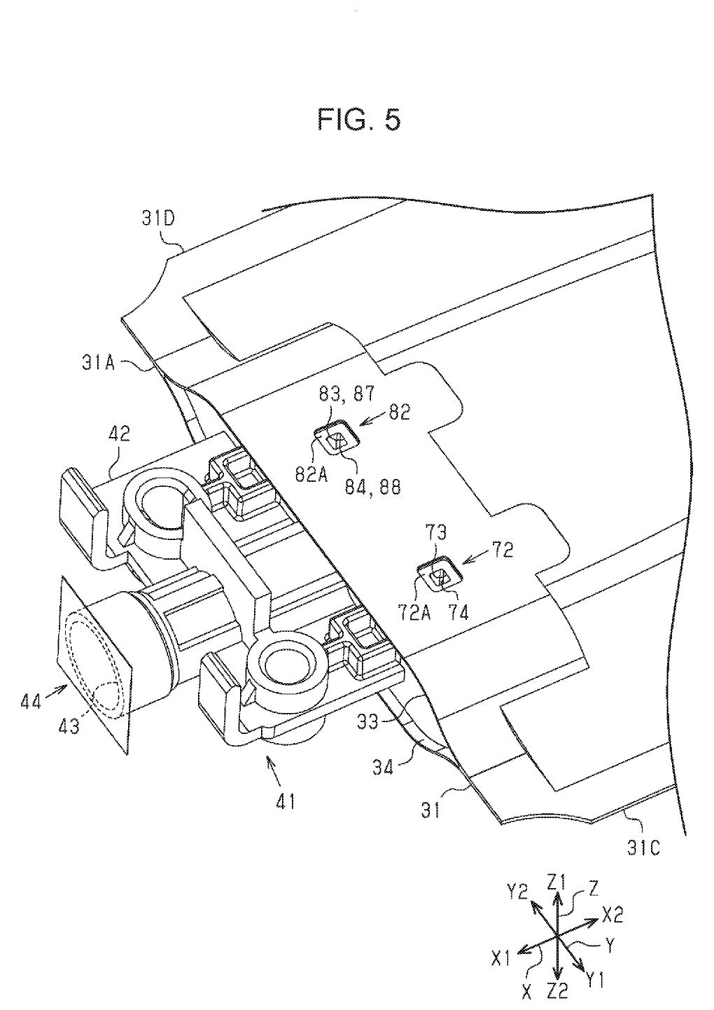

As shown in FIG. 5, when the liquid is to be poured into the liquid accommodation body 30 for the second time or later, the first sheet member 33 welded to the first protruding portion 72 and the second protruding portion 82 is removed. Accordingly, the first liquid pouring port 73 and the second liquid pouring port 83 are opened.

Thereafter, the pouring pipe 24 is inserted into the first liquid pouring port 73 and the second liquid pouring port 83 in a state where the first liquid pouring port 73 and the second liquid pouring port 83 are open. Accordingly, liquid is poured into the accommodation bag 31 through the first liquid pouring port 73 and the second liquid pouring port 83.

After the liquid is poured into the accommodation bag 31 through the first liquid pouring port 73 and the second liquid pouring port 83, seal members are welded to the first liquid pouring port 73 and the second liquid pouring port 83. Accordingly, the first liquid pouring port 73 and the second liquid pouring port 83 are sealed.

It is possible to seal the first liquid pouring port 73 and the second liquid pouring port 83 again by covering the first liquid pouring port 73 and the second liquid pouring port 83 with seal members (not shown) from the first thickness direction Z1 side after the liquid is poured and welding the seal members. The first sheet member 33 may be removed by being irradiated with a laser or the like.

The first protruding portion 72 and the second protruding portion 82 are provided to be higher than the welding end portion 54 and the confluence portion 55 in the first thickness direction Z1. Therefore, reliability with which the first liquid pouring port 73 and the second liquid pouring port 83 are sealed by the first sheet member 33 can be improved.

Particularly, when seal members are welded to the first liquid pouring port 73 and the second liquid pouring port 83 a plurality of times, the first protruding portion 72 and the second protruding portion 82 are not made lower than the welding end portion 54 and the confluence portion 55 in the first thickness direction Z1 even when the first protruding portion 72 and the second protruding portion 82 are melted due to welding heat. Therefore, reliability with which the first liquid pouring port 73 and the second liquid pouring port 83 are sealed by the seal members can be improved.

### Operation and Effect of First Embodiment

The operation and effect of the first embodiment will be described.

1-1. The first liquid pouring port 73 is a region covered by the first end portion 31A and is provided upstream of the valve structure 53. According to such a configuration, liquid can be poured into the accommodation bag 31 via the first liquid pouring port 73 in the region covered by the first end portion 31A without being restricted by the valve structure 53. Accordingly, it is not necessary to cut a large portion of the accommodation bag 31. Therefore, it is possible to suppress a decrease in amount of liquid that can be accommodated in the accommodation bag 31. Accordingly, the reusability of the liquid accommodation body 30 can be improved. Therefore, it is possible to improve convenience regarding the pouring of liquid into the liquid accommodation body 30.

1-2. The first liquid pouring port 73 is provided at the first protruding portion 72 of the supply portion 41 and is sealed in a state of being covered by the accommodation bag 31. According to such a configuration, the first protrusion surface 72A surrounds the first liquid pouring port 73 on all sides. Therefore, the first sheet member 33 can stably seal the first liquid pouring port 73 by being welded to the first protrusion surface 72A. Accordingly, liquid leakage can be prevented. Therefore, it is possible to improve convenience regarding the pouring of liquid into the liquid accommodation body 30.

1-3. The first liquid pouring port 73 is open in the first thickness direction Z1. The first protruding portion 72 is configured to protrude in the first thickness direction Z1. According to such a configuration, the first liquid pouring port 73 is provided at a position different from the liquid supply port 43. In the present embodiment, the liquid supply port 43 is provided on the mounting direction X1 side of the supply portion 41. The first liquid pouring port 73 is provided on the first thickness direction Z1 side of the supply portion 41. Accordingly, the first liquid pouring port 73 can be provided at a position at which the first liquid pouring port 73 does not interfere with the liquid supply flow path 44 at the time of an operation of pouring liquid into the first liquid pouring port 73. Therefore, it is possible to improve convenience regarding the pouring of liquid into the liquid accommodation body 30.

1-4. The first liquid pouring port 73 is open in the first thickness direction Z1 and is provided in the first width direction Y1 with respect to the liquid supply flow path 44. According to such a configuration, the first liquid pouring port 73 can be provided at a position at which the first liquid pouring port 73 does not interfere with the liquid supply flow path 44. Specifically, the first liquid pouring port 73 is open in the first thickness direction Z1, and the first pouring flow path 74 is provided to extend in a direction along the second thickness direction Z2. Therefore, the first liquid pouring port 73 and the first pouring flow path 74 are provided in the first width direction Y1 with respect to the liquid supply flow path 44 and thus the first pouring flow path 74 does not interfere with the liquid supply flow path 44. Accordingly, poured liquid can reach the accommodation bag 31. Therefore, it is possible to improve convenience regarding the pouring of liquid into the liquid accommodation body 30.

1-5. The supply portion 41 includes the second liquid pouring port 83. The second liquid pouring port 83 is provided upstream of the valve structure 53. The first liquid pouring port 73 and the second liquid pouring port 83 are provided at such positions that the liquid supply flow path 44 is interposed therebetween in the first width direction Y1.

According to such a configuration, liquid can be poured through both the first liquid pouring port 73 and the second liquid pouring port 83. As a result, the number of positions through which liquid is poured can be increased. In addition, since liquid is poured through both the first liquid pouring port 73 and the second liquid pouring port 83, the amount of liquid that can be poured per unit time can be increased. Therefore, it is possible to improve convenience regarding the pouring of liquid into the liquid accommodation body 30.

### Second Embodiment

Next, a second embodiment will be described. In the following description, redundant description of the same configurations as those in the embodiment already described will be omitted or simplified, and configurations different from those in the embodiment already described will be described.

As shown in FIG. 5, in the second embodiment, the second pouring portion 81 may include an air bubble discharge port 87. That is, the supply portion 41 may include the air bubble discharge port 87. Particularly, in the second embodiment, the second liquid pouring port 83 may be the air bubble discharge port 87.

The air bubble discharge port 87 may be provided upstream of the valve structure 53. The first liquid pouring port 73 and the air bubble discharge port 87 may be provided at such positions that the liquid supply flow path 44 is interposed therebetween in a direction along the first width direction Y1.

In the second embodiment, the second pouring portion 81 may include an air bubble discharge flow path 88. That is, the supply portion 41 may include the air bubble discharge flow path 88. Particularly, in the second embodiment, the second pouring flow path 84 may be the air bubble discharge flow path 88.

The air bubble discharge port 87 and the air bubble discharge flow path 88 are configured such that air bubbles in the accommodation bag 31 can be discharged therethrough. The air bubble discharge flow path 88 may be configured such that air bubbles in the accommodation bag 31 can be discharged through the air bubble discharge flow path 88 when liquid is poured into the accommodation bag 31 through the first pouring portion 71. The air bubbles in the accommodation bag 31 are discharged through the air bubble discharge flow path 88 and the air bubble discharge port 87. The second pouring portion 81 may be an air bubble discharge portion.

### Operation and Effect of Second Embodiment

The operation and effect of the second embodiment will be described.

2-1. The supply portion 41 includes the air bubble discharge port 87. The air bubble discharge port 87 is provided upstream of the valve structure 53. The first liquid pouring port 73 and the air bubble discharge port 87 are provided at such positions that the liquid supply flow path 44 is interposed therebetween in the first width direction Y1.

According to such a configuration, the air bubble discharge port 87 is provided separately from the first liquid pouring port 73. Therefore, the liquid accommodation body 30 is configured such that liquid can be poured into the liquid accommodation body 30 while air bubbles are being discharged. Specifically, liquid is poured through the first liquid pouring port 73. Air bubbles are discharged through the air bubble discharge port 87 by being pushed out by the liquid poured through the first liquid pouring port 73. Accordingly, a variation in amount of poured liquid that is caused by air bubbles when liquid is poured can be suppressed. In addition, the first liquid pouring port 73 and the air bubble discharge port 87 are provided at such positions that the liquid supply flow path 44 is interposed therebetween in the first width direction Y1 so that the first pouring flow path 74 and the air bubble discharge flow path 88 do not interfere with the liquid supply flow path 44. Therefore, it is possible to improve convenience regarding the pouring of liquid into the liquid accommodation body 30.

### Third Embodiment

Next, a third embodiment will be described.

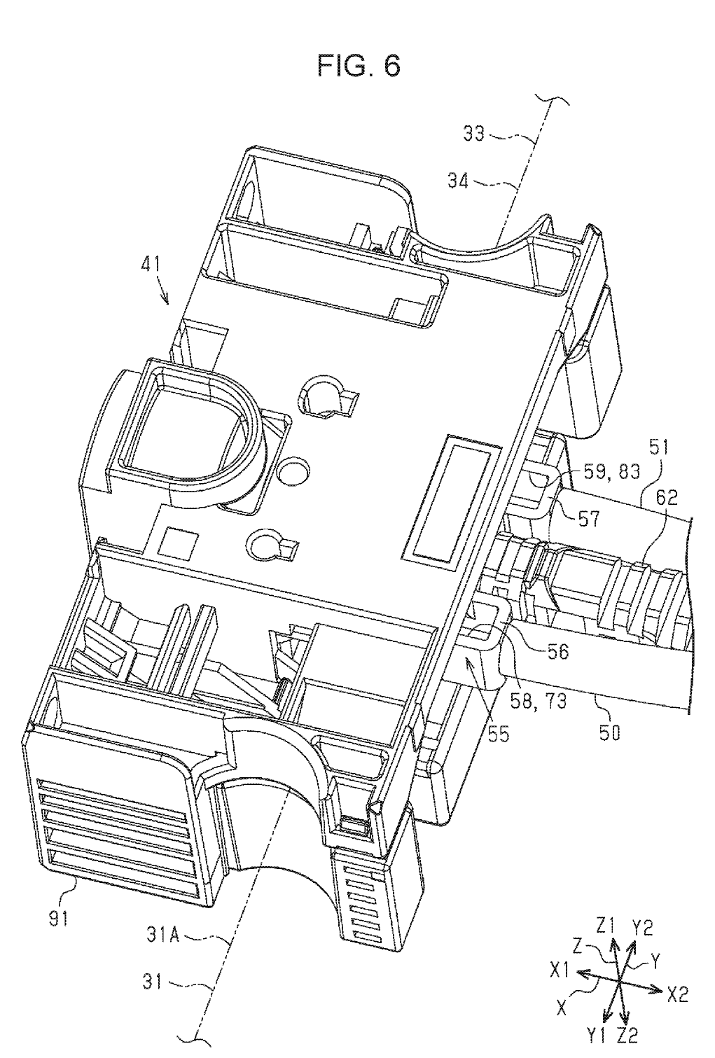

As shown in FIG. 6, in the third embodiment, liquid may be poured through both the first opening 58 and the second opening 59. That is, the first opening 58 may be an example of the first liquid pouring port 73. The second opening 59 may be an example of the second liquid pouring port 83.

An adapter 91 may be attached to the supply portion 41. The adapter 91 is attached to the supply portion 41 such that the adapter 91 does not cover the first opening 58 and the second opening 59 on the first thickness direction Z1 side.

In this manner, the first sheet member 33 welded to the first upper surface 56 and the second upper surface 57 can be removed even when the adapter 91 is not removed from the supply portion 41. Accordingly, the first opening 58 and the second opening 59 enter a state of being exposed from the adapter 91.

Thereafter, liquid can be poured into the accommodation bag 31 through the first opening 58 and the second opening 59, which are open in the first thickness direction Z1, even when the adapter 91 is not removed from the supply portion 41. Then, the first opening 58 and the second opening 59 are sealed again.

### Modification Example

The present embodiment can be modified and implemented as follows. The present embodiment and the following modification example can be implemented in combination with each other in a technically consistent range.

In the second embodiment, the first liquid pouring port 73 may be the air bubble discharge port 87 instead of the second liquid pouring port 83. In the second embodiment, the first pouring flow path 74 may be the air bubble discharge flow path 88 instead of the second pouring flow path 84. That is, in the second embodiment, any one of the first pouring portion 71 and the second pouring portion 81 may include the air bubble discharge port 87 and the air bubble discharge flow path 88.

In the first embodiment and the second embodiment, liquid may be poured through the first liquid pouring port 73 at the first pouring portion 71 not via the liquid supply port 43 and the confluence flow path 45 after removal of the first sheet member 33 even when liquid is to be poured into the liquid accommodation body 30 for the first time. In this case, the first sheet member 33 may be welded to the first protrusion surface 72A. In this case, the first protrusion surface 72A may not be provided with the first projecting portions 75. The supply member 42 may not include the first bypass region 48. The same applies to the second pouring portion 81 as the first pouring portion 71.

In the third embodiment, any one of the first opening 58 and the second opening 59 may be configured such that air bubbles in the accommodation bag 31 can be discharged therethrough. That is, the first opening 58 may be an example of a liquid pouring port. The second opening 59 may be an example of an air bubble discharge port. For example, liquid may be poured into the accommodation bag 31 through the first opening 58 and the first tube 50 and air bubbles in the accommodation bag 31 may be discharged through the second opening 59 and the second tube 51.

In the third embodiment, the adapter 91 may be provided with an opening through which it is possible to access each of the first pouring portion 71 and the second pouring portion 81 on the first thickness direction Z1 side with respect to the adapter 91. The number of such openings may be one or two or more.

In the third embodiment, the accommodation bag 31 may be accommodated in a case member (not shown). The case member may be provided with an opening through which it is possible to access each of the first pouring portion 71 and the second pouring portion 81. The case member may be provided with an opening through which it is possible to access each of the first opening 58 and the second opening 59. The number of such openings may be one or two.

The supporting portion 62 may be provided with a filter. The filter filters liquid in the accommodation bag 31. The filter may be provided on the separation direction X2 side with respect to the supporting portion 62. The filter may be integrated with the supporting portion 62 or may be provided separately from the supporting portion 62. The upstream end of the first tube 50 and the upstream end of the second tube 51 may be coupled to the filter.

An elastic member (not shown) may be press-fitted instead of the spring valve in the valve structure 53. The valve structure 53 may be configured to open the valve by piercing the supply pipe 23 with the elastic member and close the valve by the pressing input of the elastic member by pulling out the supply pipe 23 from the elastic member.

The first liquid pouring port 73 and the second liquid pouring port 83 may not be provided at positions arranged in the direction along the first width direction Y1. The first liquid pouring port 73 and the second liquid pouring port 83 may not be provided at such positions that the valve structure 53 is interposed therebetween in a direction along the Y-axis.

The first liquid pouring port 73 and the second liquid pouring port 83 may be provided at any positions as long as the first liquid pouring port 73 and the second liquid pouring port 83 are provided upstream of the valve structure 53. The first liquid pouring port 73 and the second liquid pouring port 83 may be provided upstream of the accommodation bag 31 or downstream of the accommodation bag 31 as long as the first liquid pouring port 73 and the second liquid pouring port 83 are provided upstream of the valve structure 53.

The liquid supply flow path 44 may be a flow path that couples at least the liquid supply port 43 and the inside of the accommodation bag 31. The liquid supply flow path 44 may include a flow path upstream of the inside of the accommodation bag 31 other than a flow path that couples the liquid supply port 43 and the inside of the accommodation bag 31.

The number of liquid pouring ports may be one, two, or three or more. That is, the supply portion 41 may include a liquid pouring port other than the first liquid pouring port 73 and the second liquid pouring port 83. The liquid accommodation body 30 may include at least any one of the first liquid pouring port 73, the second liquid pouring port 83, the first opening 58, and the second opening 59.

The expression “at least any one” used in the present specification means one or more of desired options. As an example, the expression “at least any one” used in the present specification means only one option or both of two options when the number of options is two. In another example, the expression “at least any one” used in the present specification means only one option or a combination of any two or more options when the number of options is three or more.

### Supplementary Notes

Hereinafter, the technical ideas and the operation and effect understood from the above-described embodiment and modification example will be described. The technical ideas and the operation and effect thereof can be combined with each other in a technically consistent range.

1. A liquid accommodation body includes an accommodation bag that accommodates liquid and a supply portion that is attached to the accommodation bag. The supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag and the liquid pouring port is a region covered by an end portion of the accommodation bag and is provided upstream of the valve structure in the liquid supply flow path.

According to such a configuration, liquid can be poured into the accommodation bag via the liquid pouring port in the region covered by the end portion of the accommodation bag without being restricted by the valve structure. Accordingly, it is not necessary to cut a large portion of the accommodation bag. Therefore, it is possible to suppress a decrease in amount of liquid that can be accommodated in the accommodation bag. Accordingly, the reusability of the liquid accommodation body can be improved. Therefore, it is possible to improve convenience regarding the pouring of liquid into the liquid accommodation body.

2. In the liquid accommodation body, the liquid pouring port is provided at a protruding portion of the supply portion and is sealed in a state of being covered by the accommodation bag. According to such a configuration, the liquid pouring port can be stably sealed at the protruding portion. Accordingly, liquid leakage can be suppressed. Therefore, it is possible to improve convenience regarding the pouring of liquid into the liquid accommodation body.

3. In the liquid accommodation body, the liquid pouring port is open in a second direction intersecting a first direction in which the liquid supply flow path extends toward the liquid supply port and the protruding portion is configured to protrude in the second direction. According to such a configuration, the liquid pouring port can be provided at a position at which the liquid pouring port does not interfere with the liquid supply flow path at the time of an operation of pouring the liquid. Therefore, it is possible to improve convenience regarding the pouring of liquid into the liquid accommodation body.

4. In the liquid accommodation body, the liquid pouring port is open in a second direction intersecting a first direction in which the liquid supply flow path extends toward the liquid supply port and is provided in a third direction with respect to the liquid supply flow path, the third direction intersecting the first direction and the second direction. According to such a configuration, the liquid pouring port can be provided at a position at which the liquid pouring port does not interfere with the liquid supply flow path. Therefore, it is possible to improve convenience regarding the pouring of liquid into the liquid accommodation body.

5. In the liquid accommodation body, the supply portion includes a second liquid pouring port through which the liquid is pourable into the accommodation bag, the second liquid pouring port is provided upstream of the valve structure in the liquid supply flow path, the liquid pouring port is a first liquid pouring port, and the first liquid pouring port and the second liquid pouring port are provided at such positions that the liquid supply flow path is interposed between the first liquid pouring port and the second liquid pouring port in the third direction.

According to such a configuration, liquid can be poured through both the first liquid pouring port and the second liquid pouring port. As a result, the number of positions through which liquid is poured can be increased. In addition, since liquid is poured through both the first liquid pouring port and the second liquid pouring port, the amount of liquid that can be poured per unit time can be increased. Therefore, it is possible to improve convenience regarding the pouring of liquid into the liquid accommodation body.

6. In the liquid accommodation body, the supply portion includes an air bubble discharge port through which air bubbles are dischargeable from the inside of the accommodation bag, the air bubble discharge port is provided upstream of the valve structure in the liquid supply flow path, and the liquid pouring port and the air bubble discharge port are provided at such positions that the liquid supply flow path is interposed between the liquid pouring port and the air bubble discharge port in the third direction.

According to such a configuration, the air bubble discharge port is provided separately from the liquid pouring port. Therefore, the liquid accommodation body is configured such that liquid can be poured into the liquid accommodation body while air bubbles are being discharged. Accordingly, a variation in amount of poured liquid that is caused by air bubbles when liquid is poured can be suppressed. Therefore, it is possible to improve convenience regarding the pouring of liquid into the liquid accommodation body.

7. A method of pouring liquid into a liquid accommodation body is a method of pouring liquid into a liquid accommodation body that includes an accommodation bag accommodating liquid and a supply portion attached to the accommodation bag and in which the supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag and the liquid pouring port is a region covered by an end portion of the accommodation bag and is provided upstream of the valve structure in the liquid supply flow path, the method including pouring the liquid into the accommodation bag through the liquid pouring port in a state where the liquid pouring port is open and sealing the liquid pouring port after the liquid is poured into the accommodation bag through the liquid pouring port. According to this configuration, the same effect as in 1. can be achieved.

What is claimed is:

1. A liquid accommodation body comprising:
an accommodation bag that accommodates liquid; and
a supply portion that is attached to the accommodation bag, wherein
the supply portion includes
a liquid supply port that is couplable to a supply pipe of a liquid discharging apparatus,
a liquid supply flow path that couples an inside of the accommodation bag and the liquid supply port,
a valve structure that suppresses intrusion of air bubbles in the liquid supply flow path, and
a liquid pouring port through which the liquid is pourable into the accommodation bag, and
the liquid pouring port is a region covered by an end portion of the accommodation bag and is provided upstream of the valve structure in the liquid supply flow path.

2. The liquid accommodation body according to claim 1, wherein
the liquid pouring port is provided at a protruding portion of the supply portion and is sealed in a state of being covered by the accommodation bag.

3. The liquid accommodation body according to claim 2, wherein
the liquid pouring port is open in a second direction intersecting a first direction in which the liquid supply flow path extends toward the liquid supply port, and
the protruding portion is configured to protrude in the second direction.

4. The liquid accommodation body according to claim 1, wherein
the liquid pouring port is open in a second direction intersecting a first direction in which the liquid supply flow path extends toward the liquid supply port and is provided in a third direction with respect to the liquid supply flow path, the third direction intersecting the first direction and the second direction.

5. The liquid accommodation body according to claim 4, wherein
the supply portion includes a second liquid pouring port through which the liquid is pourable into the accommodation bag,
the second liquid pouring port is provided upstream of the valve structure in the liquid supply flow path,
the liquid pouring port is a first liquid pouring port, and
the first liquid pouring port and the second liquid pouring port are provided at such positions that the liquid supply flow path is interposed between the first liquid pouring port and the second liquid pouring port in the third direction.

6. The liquid accommodation body according to claim 4, wherein
the supply portion includes an air bubble discharge port through which air bubbles are dischargeable from the inside of the accommodation bag,
the air bubble discharge port is provided upstream of the valve structure in the liquid supply flow path, and
the liquid pouring port and the air bubble discharge port are provided at such positions that the liquid supply flow path is interposed between the liquid pouring port and the air bubble discharge port in the third direction.

7. A method of pouring liquid into a liquid accommodation body that includes an accommodation bag accommodating liquid and a supply portion attached to the accommodation bag and in which the supply portion includes a liquid supply port that is couplable to a supply pipe of a liquid discharging apparatus, a liquid supply flow path that couples an inside of the accommodation bag and the liquid supply port, a valve structure that suppresses intrusion of air bubbles in the liquid supply flow path, and a liquid pouring port through which the liquid is pourable into the accommodation bag and the liquid pouring port is a region covered by an end portion of the accommodation bag and is provided upstream of the valve structure in the liquid supply flow path, the method comprising:
pouring the liquid into the accommodation bag through the liquid pouring port in a state where the liquid pouring port is open; and
sealing the liquid pouring port after the liquid is poured into the accommodation bag through the liquid pouring port.
